(19) United States
(12) Patent Application Publication
(10) Pub. No.: US 2011/0126737 A1
(43) Pub. Date: Jun. 2, 2011

(54) METHOD FOR RECYCLING OILY WASTE IN ORDER TO PRODUCE A MULTI-USE DRY-TYPE MODIFIED PAVEMENT

(76) Inventors: Francisco Andres Alfonsin Pym, Col. Maria de la Piedad (MX); Guillermo Chavero Lopez, Col. Maria de la Piedad (MX)

(21) Appl. No.: 12/993,507

(22) PCT Filed: May 20, 2009
(86) PCT No.: PCT/MX09/00045

§ 371 Date: Dec. 21, 2010

(30) Foreign Application Priority Data
May 21, 2008 (MX) MX/A/2008/006540

(51) Int. Cl. C04B 18/18

(52) U.S. Cl. 106/697

(57) ABSTRACT

The invention relates to a treatment process or recycling co process for oily wastes originating from the use of hydrocarbons, products manufactured therefrom and derivatives of same, without using aggregates from natural banks during the transformation process, thereby producing a novel material which can be used as an aggregate in hydraulic or asphaltic rolling surfaces, road sub-bases, bases and repair work involving cold patching, and which has the following mechanical characteristics and properties: zero plasticity; non toxicity; insolubility and impermeability to water, which prevents any form of leaching during the handling or use thereof; and optimum CBR and compacting, reducing construction times and costs and any negative impact on the environment, through the sustainable use of wastewater streams.

### BACKGROUND OF THE INVENTION

Nowadays, heavy-fraction oily wastes incalculable amounts are created, during the process of hydrocarbons exploitation and manufacturing and derivatives thereof (smudges, sludge, emulsions, ground deposits, oils and worn oils), conventional control and handling methods for said wastes, generally are based on the physical-chemical breakup of said compounds, comprising this type of wastes (solids-oil-water); disintegration through thermal destruction, somewhat creates carbon dioxide, a gas to which the international scientific community attributes the global warm; and confinement that in environmental terms, it is the pollution or contamination emission from one side to another.

These wastes are so defined in general terms, so that are not useful for the generating productive process, nor in other processes that may be used as raw materials, besides, pollutants are defined as leached particles emitted when being exposed inadequately to the environment in (water bodies or ground), independently from the fact that are dangerous or not, due to toxicity level thereof, is determined by the CRETI characteristics, through specialized laboratory's analysis practice to said wastes, established as a standard in some legislations according to the security and safety codes, CRETI means for its spanish abbreviation (corrosive, reactive, explosive, toxicant, inflammable). Said handling and control nevertheless operate according to the international environmental restrictions, that weight the proximity principal, confining wastes generators to be recycled and wastes to be reused, recommending to be treated the nearest possible to the site where they were created, and at the time restricting, burning and discretional confinement, establishing that said handling and treatment forms shall be the last options chosen by generators to treat or handle wastes thereof, Petróleos Mexicanos Environmental Profile 1988, Cultura Ecológica ac. 1989; Promotion of Hazardous Wastes Minimization Promotion or Fostering, Red Mexicana de Manejo Ambiental de Residuos (Mexican Network for Wastes Environmental Handling) (Remexmar) affiliated to the Wastes Environmental Handling Panamerican Network (Red Panamericana de Manejo Ambiental de Residuos) (Repamar) Ine-Semarnat-1999; The Convention of Basilea 1999; Transborder Movements and Wastes Environmental Handling; the Kyoto Protocol upon weather changes Feb. 10, 2005.

Handling said heavy-fractioned oily wastes, represented by said generators, high cost for confinement and transportation risks, industrially said wastes did not have any profit in conventional process, as we may ensure that are feasible to be universally taken advantage of as raw materials, so that it consists of the transformation of oily wastes derived from petroleum or oil in this new material. It is recognized that only in Switzerland a minimum part of said oily wastes is incorporated, through the traditional process for manufacturing asphalts, pavements, which lies in, proportioning said wastes combustible liquid phase, to the rotating oven burning injection, and sediments are incorporated to the natural banks and asphalt aggregates metrics to dissipate solid wastes in an environmentally safe measures and reduce negative impact to the environment, another common and rural form of treating said oily wastes is thickening said wastes, mixing with raw soils and hydrated calcium oxide (limes) for elaborating the wrongly called “black bases for low traffic”, without soils mechanics control, since the standard black bases, shall support 4kg/cm2 minimum; this primitive form of oily wastes treatment, is inconvenient to be applicable, for the resulting mixture in rolling surfaces without running the risk of contaminating by lixiviates to the circumscribing zones, besides that its support relative value is null for high plasticity, said mixtures have mechanical properties that shall be observed by soils mechanics engineering quality control, to conform any rolling surface, so we may ensure that said mixtures in combinations, when not having any minimum specifications and mechanical properties for building materials, this mixture shall be considered as wastes, since the use thereof gives rise to deforming structures where said mixtures are deposited or stored, besides contributing in environmental terms to a dilution, by the use of raw soils bank materials, used to manufacture said mixtures with oily wastes derived from debris or wastes of hydrocarbon exploitation.

On the other hand, soil mechanics engineering for traditional pavement building, demands a natural banks material shortage and demand, which are used for aggregates in elaborating asphalt or hydraulic concretes, terrace bodies, roads bases and sub-bases, said materials from natural banks are selected according to the Unified System of Soils Classification by its spanish abbreviations (SUCS) materials having the physical property of owning a (V.R.S) that means according to its spanish abbreviation (support relative value) as the minimum of the 20% and compacting in standard range, the minimum proctor or ASSTHO testing of the 90%, so pavements foundations may support traffic loads without being deformed, that nevertheless, roads are the main part of the communities urban development, impacting the environment negatively by the cut and use of natural bank materials.

### OBJECTS OF THE INVENTION

One of the objects of the invention is to harmonize both engineering fields, to offer a sustaining alternative, both in environmental matters, and soils mechanic engineering, to promote wastes generators in the industrial and oil industries, that enables recycling and economically take advantage of wastes when being transformed in a quality material, to reduce negative impact to environment due to the cut and use of natural bank materials, at least in the volume that said wastes type are generated.

Another object of the invention is creating a new procedure, by recycling oily wastes derived from oil and expired materials without using any aggregates or bank materials, during transformation processes. As well as to prevent burning or confining said wastes without any object, to prevent negative impact to the environment in said oily wastes handling forms.

Another object of the invention is to prepare these new materials with physical and mechanical properties, not having natural bank materials, but using the new materials (multi-use dry-type modified pavement) as is insolubility and permeability to water, high compacting methods, cementing, cohesiveness and resistance to axial compression, low plasticity of this new modified pavement, since plasticity and humidity absorption of natural bank materials are a determining factor of pavement structures failures. As well as avoiding negative impact to the environment by bleaches of hydrocarbon creating the use of some traditional materials of the asphalt carpet during handling and application in roads rolling carpet construction processes.

These and other objects in the environmental and soil mechanics engineering, shall be evident as of the following detailed description of the invention (method of recycling oily waste in order to produce a multi-use dry-type modified pavement) in which the series of the procedures stages shall be disclosed as well as the product or composition technical characteristics.

### DETAILED DESCRIPTION OF THE INVENTION

The best method to carry out the present invention is the following:

Oily waste are valued to manufacture multi-use dry-type modified pavement, featuring the oily wastes by its chemical composition and toxicological characteristics thereof with the laboratory analysis (CRETI) and hydrocarbon total part concentrations are analyzed (TPH'S) present in sludge, smudges, emulsions or oily sediments, excepting the handling and evaluation for using as raw materials the oily-type wastes comprising polychlorated and exachlorated biphenyl.

In the following step or stage, CRETI characteristics stipulated by non-semarnat-052-2003 are determined, that by the spanish abbreviation means (corrosiveness, reactivity, explosiveness, toxicity, flammability) and total hydrocarbon parts by its english abbreviations means total, parts hydrocarbons (TPH'S), that translated into spanish means total hydrocarbon parts, established by rule 418.1 from the environmental protection agency, proceeding to homogenize wastes according to volume and density thereof whether manually or mechanically (with shovels, diggers or mechanical systems) for the homogeneity froze is constantly made, adding hydrogen, peroxide compound, and surfactant in a ratio for each 1 m3 of smudge or oily materials, using a mixture of 1 to 12 liters (depending on the residue density) with hydrogen peroxide with water at a ratio of 50-50%, simultaneously, adding a mixture of 1 to 12 liters of ammonia-sulfate based degreaser with water at 50-50%, acting as fluidifier, and vapor suppressors, mass humidity to be homogenized shall comprise certain humidity fluctuating between 10 and 20% maximum.

Once a homogenous consistency is achieved, and until obtaining the optimum and fluidizable density, breaking up the mixture for the texture and viscosity change shall be observed, specifying the optimum point to continue to commercial calcium oxide integration or sandwiched, which is added homogenizing constantly in a 1:1 ratio with the TPH'S concentration (total hydrocarbon parts comprising the volume of wastes to be transformed), example: sludge volume is 1 m3 having a TPH'S concentration from 20 to 30%, calcium oxide to be used and dosed shall be 20 to 30%, said doses may vary also related to the humidity percentage, the higher humidity is the higher proportioning ratio will be.

During the chemical reaction process that lasts approximately 45 minutes according to the volume to be treated, to prevent any type of contamination or pollution to the atmosphere, vapors with bell-type dome and extractors are captured, so vapors once condensed through venturi-type system, to be collected, by cooling tanks. Condensates recovered during chemical reaction process are filtered with activated carbon and said recovered and filtered liquid phase is reincorporated to the process initial stage to mix and homogenize wastes.

Constantly homogenizing is next step, until absorbing exothermically reaction and total evaporating stage of humidity of the mass to be transformed, as a result, obtaining granulates of organoleptic presence with a clay appearance with granulometry of ¼ to fines particles, non greasy at touch.

Granulates are cooled, not showing any traces nor oil traces, practice to this test, jar filtering test introducing a portion thereof in a glass bottle that shall be mixed with water, shall not present any oil traces, materials shall be settled, water shall become transparent or crystal-clear, only in the surface somewhat suspension fines will be observed by the specific weight of material fraction which is lighter than water in lucent state, in comparison to natural bank materials.

Proceeding to characterize a material with assays established by soil mechanic engineering for quality control of this new (multi-use dry type modified pavement) which range of compacting level shall not be less than 90% in proctor or ASSTHO test ranges, modified; it is said that it is modified since the modified test due to the low humidity ratio required by this new material to analyze said ranges and parameters. Support relative value (V.R.S) shall not be less than 20%, its optimal humidity point for application shall be from 6 to 8.8% maximum of humidity, for optimal compacting level in comprising structures in the above specified uses, that ensure the compacting, cementing and adherence quality control, to be used in constructive processes or hydraulic or asphalt pavements repair.

Simultaneously, it is analyzed with each CRETI analysis material lot representative sample, to determine that it has not characteristic with said environmental safety code.

Physical-chemical properties of the new (multi-use dry-type modified pavement) by its permeability to water, prevents sludge formation when being consolidated uniformly according to roads base or sub-base structures, physical, mechanical property having this new material that works as isolating agent and distributes loads uniformly, its use avoids failure by humidity of asphalt or hydraulic pavement structures, this development is based on the regulating evaluation of materials and expired wastes of oily-type, for being used as raw materials for preparing universally a new multi-use dry-type modified pavement.

This new material, owns the following mechanical properties and physical-chemical specifications and characteristics.

Color: sand-type beige varying from the suigeneris clear to dark tone

Odor: light odor to hydrocarbons

Toxicity: non CRETI

Ph: 6 to 9% anti-acid type

Chemical composition: water-insoluble carbonate (COCO3).

Granulometry: from ¼ to fines.

Compacting degree: minimum 90%

Permeability to water: compacted is 100% permeable.

Water-solubility: 100% insoluble to water.

Support relative value: variable range from 20 to 100%.

Maximum humidity degree: for optimal compacting degree 8.8%.

Cementing in cold: without any aggregates of commercial substances, asphalt base or polymers, to achieve conforming structures in hydraulic or asphalt concrete pavements lower layers.

Volumetric variation applied and compacted: compacted, not showing volumetric variations, characteristics that may roads (highways) structures stable, where the material is applied.

esistance to Simple Axial Compression: from 10 to 24 kg/cm2.

Minimum loose specific weight kg./m3: 950

Maximum compacted specific weight kg./m3: 1825

Variation of physical and mechanical properties to exposure to the environment or outdoors conditions: none

Multi-use dry-type modified pavement compacted or applied: once again, may be disaggregated and reused in any other places, without the material suffers any change in its physical-chemical properties.

### Use and Applications

(only humidity at optimal point with a minimum variation of 6% that must not be greater than 8.8%).
cold patching
terrace body conforming
roads bases and sub-bases to improve asphalt or hydraulic concrete carpet uniformity
core for dam containment
bridges ramps and approaches
containment
dirt roads seal or lining
crossings (shallow places where rivers cross) in secondary roads
absorption joints and expansion joints between pavements
secondary roads lining
combinations with solid aggregates and commercial asphalt substances, to rise resistances in ranges and specifications of pavements or patching products, within the standards established by soils mechanics engineering.

### Handling Forms

Bulk bank storage, prior to any of applications or packaging for marketing, material does not lose its mechanical properties as time goes by.

Oily wastes recycling technique application for manufacturing multi-use dry-type modified pavement, prevents and avoids in the environmental material the risks of transportation of wastes to confinement or to thermal destruction, when manufacturing the new (multi-use modified pavement), eliminating the use of natural bank materials during the transformation process from wastes to materials, after the transformation, it is feasible to use this new material with solid aggregates to achieve optimum resistance in soils mechanic engineering, its use prevents from relevant delays due to rain in the building process of dirt roads in general.

As it has been described and appreciated, these oily wastes method of recycling, as we may ensure, cost-efficiently solves issues in environmental matters, when avoiding the inadequate handling of this type of wastes that commonly program for sending to confinement or thermal destruction, that the atmosphere issues for example carbon dioxide, gas to which the international scientific community attributes the cause of global warm and soils mechanic engineering eliminates the use of natural bank materials, during the process of transforming wastes that give rise to dilutions, reducing also the use of bank materials in the proportion in which this new material is obtained and used for the asphalt or hydraulic conventional pavements redesigned or building, that represents the relevant reduction of negative impacts to the environment in both engineering fields.

The differences existing between multi-use dry-type modified pavement and asphalt and hydraulic traditional pavements are:

Multi-use dry-type modified pavement, is obtained through oily wastes recycling and expired materials, by accelerated chemical oxidation, without using any aggregates or bank materials, during the process of transforming from the wastes in this material, in an approximate period of 45 minutes, this material has physical and mechanical properties of being water, insoluble and permeable, of high compacting and cementing decree, adherence and cohesively and null plasticity, its use enables the instantaneous consolidation to compression or axial loads, to conform pavement structures and repairing due to patching or filling out fractures on asphalt or hydraulic pavements, properties that allow cold application without any additives whatsoever, such as water irrigation or emulsions.

Not requiring any setting to consolidate and to comprise a solid and stable structure with VRS in a variable range as minimum of the 20%, these physical-mechanical properties of the new material, are valued in field which considerably reduce times and costs in the building process, in comparison with the building processes where only conventional aggregates are used for traditional pavements construction, and achieving with the use of this new material opening the traffic in very reduced times in comparison to the time required for the construction processes used with common bank materials.

Hydraulic concrete pavements, compared to the multi-use dry-type modified pavement, is that the mixture from raw materials is obtained, as is portland cement and natural bank aggregates, prior graduation and selection by meshes and it is applied by mixing aggregates and cement with water for setting, requiring several hours or days for the confront structure reaches it optimal strength and resistance for supporting structural loads.

Asphalt pavement is obtained through conventional process, mixing in furnaces, rotating-type the asphaltic emulsions and bank materials selected (raw materials) to obtain the asphalt concrete, this is lay and compacted according to the structure and cold or hot application asphalt emulsions impregnation is added, irrigation to comprise a vehicle-road carpet or for repairing road holes that support structural loads, requiring several hours for the application thereof and to allow traffic opening.

Multi-use dry-type modified pavement made through oily wastes recycling, due to its water-permeability, avoids any type of bleaching of hydrocarbon compounds that comprise the above, protecting border and soil bodies for the material is applied, physical properties of this new material as water insolubility avoids sludge forming when consolidating uniformly, and conforming base or sub-base road structures, physical-mechanical property which works as an isolating agent that besides distributes loads uniformly, which avoids failure due to humidity of the structures of asphalt and hydraulic pavement for this new modified pavement is applied.

This new material is susceptible of combinations with solid aggregates and substances which are commercial and asphalt derived, to achieve ranges and specifications in optimum standards established by soil mechanical engineering.

Development based on wastes regulating assessment and employment thereof as raw materials for transforming for the accelerated chemical oxidation co-process, and for manufacturing universally the multi-use dry-type modified pavement.

1. A method for obtaining or manufacturing multi-use dry-type modified pavement, through recycling oily wastes, comprising the following stages; selecting the material from which oily wastes are derived, from oil to determine and analyze corrosiveness, reactivity, explosion, flammability and toxicity of materials, analyze concentration of total present hydrocarbon parts in sludge or oily sediments, excepting handling and assessment for the use thereof, as raw materials the wastes containing polychlorated and exachlorated biphenyles, the following step or stage is to homogenize the wastes according to their volume and density, manually (shovels) or mechanically (diggers, blenders, etc.) wherein the stage of adding for each 1 m3 of sludge or oily material, a 1 to 12 liters mixture (depending on the wastes density) of hydrogen peroxide with water to the 50-50%, simultaneously, adding a mixture from 1 to 12 liters of degreaser ammonium sulfate-base (with water) to 50-50%, acting as fluidifier and vapors suppressor.

2. The method for obtaining or manufacturing multi-use dry-type modified pavement, based on recycling oily wastes, according to claim 1, wherein further by the stage of providing to the mixture, a homogenous consistence until obtaining an optimal and fluidifying density allowing the integration of calcium oxide homogenously, adding homogenizing constantly calcium oil oxide in a maximum ratio of 1:1 with the concentration of total hydrocarbon parts comprising the residue to be transformed in material, with the sludge volume of 1 m3 and having total hydrocarbon parts concentration from 20 to 30%, calcium oxide to be use shall be from 20 to 30%, these doses may vary also with regarding to the humidity percentage, the higher humidity, the dosing ration will be increased.

3. The method for obtaining or manufacturing multi-use for dry-type modified pavement, for recycling oily wastes according to claim 1, wherein further for the reaction stage, lasting approximately 45 minutes, where in order to prevent any type of pollution or contamination to the atmosphere, vapors with bell-type domes and extracting are characterized, so that vapors be condensed through a venturi-type system, to be collected in cooling tanks, recovered condensate during the chemical reaction process are filtered with activated carbon and said recovered and filtered liquid phase is reincorporated to the initial stage at the process to mix and homogenize wastes.

4. A method for obtaining or manufacturing dry-type modified pavement through oily wastes recycling, according to claim 1, wherein further due to their constant homogenization stage until observing the exothermal reaction and the total humidity evaporation of the mass to be transformed, as a result a granulate is obtained that through organoleptical appreciation has the appearance of a clay with ¼ of fines granulometry clay is observed, non greasy at touch.

5. A method for obtaining or manufacturing (multi-use dry-type modified pavement) through recycling oily wastes according to claim oily wastes according to claim 1, comprising the stage of cooling granulates, the above does not show oily traces, it is practiced to this test and introducing a portion thereof in a glass bottle and mix with water, water does not show any oily traces, the material is settled, the water shall become clear, only in the surface fines in suspension are observed, due to the specific weight of the material fractions which is lighter than water, total material specific weight results lighter, in comparison to natural bank materials.

6. A method for obtaining or manufacturing multi-use dry-type modified pavement, through recycling oily wastes according to claim 1, wherein through the stage of carrying out to the material, soils mechanic assays, whose compacting range shall not be less than 90% in the proctor or asstho test, modified by low humidity ratio. Its supporting relative value shall not be less than 20%, which humidity optimum point fluctuates between 6 and 8.8%, for its optimal compacting stage, which guarantees a high compacting degree, cementing and adherence, to be used in pavement building processes.

7. Multi-use dry-type modified pavement, made based on oily wastes derived from petroleum or oil, comprising the combination of oily smudges to which a concentration of calcium oxide of 20 to 30 percent is applied, to previously homogenize suspension wastes, until forming a material with ¼fines granulometry material, characterizing this new material, which elaboration requires the wastes fluidization for each 1 m3 of sludge or oily material to a mixture of 1 to liters (depending on the residue's density) of hydrogen peroxide with water to 50-50%, simultaneously, adding a mixture of 1 to 12 liters of degreaser based on ammonium-sulfate with water to 50-50%; acting as fluidifier and vapors suppressor, to reach chemical reactions for obtaining said material.

8. Multi-use dry-type modified pavement, is an oily wastes-based material derived from oil according to claim 7, wherein the support relative value of the material is 20 percent as minimum.

9. Multi-use dry-type modified pavement, is an oily wastes-based material derived from oil according to claim 7, wherein due to the loose specific weight is minimum of 950 kilograms per cubic meter and its maximum specific weight (compacted) is 1850 kilograms per cubic meter.

10. Multi-use dry-type modified pavement, is an oily wastes-based material derived from oil according to claim 7, wherein further the optimum humidity degree for cold compacting is 6 and 8.8 percent.

11. Multi-use dry-type modified pavement, is an oily wastes-based material derived from oil according to claim 7, wherein further the material hydrogen potential is from 6 to 9 percent.

12. Multi-use dry-type modified pavement, is an oily wastes-based material derived from oil according to claim 7, wherein further its storing does not have any expiration date since the material does not loss mechanical properties prior to its use.

13. Multi-use dry-type modified pavement, is an oily wastes-based material derived from oil according to claim 7, wherein for the application thereof and due to physical-mechanical properties, setting is not required, for the use thereof only compacting specifications required to comprise the structure under optimal specifications of material mechanical properties, without adding any additive to consolidate this material.

14. Multi-use dry-type modified pavement, is an oily wastes-based material derived from oil according to claim 7, wherein it is useful for pavements redesigned, so it is susceptible of combinations with solid aggregates and commercial asphalt substances, to reach the optimum standards specifications and ranges established by soils mechanic engineering.
